(19) United States
(12) Patent Application Publication
(10) Pub. No.: US 2021/0283790 A1
(43) Pub. Date: Sep. 16, 2021

(54) KNIFE

(71) Applicant: Isaac H. Cohen, Phoenix, AZ (US)

(72) Inventor: Isaac H. Cohen, Phoenix, AZ (US)

(21) Appl. No.: 17/187,639

(22) Filed: Feb. 26, 2021

Related U.S. Application Data
(63) Continuation-in-part of application No. 29/727,730, filed on Mar. 12, 2020, now Pat. No. D923740.
(60) Provisional application No. 62/988,873, filed on Mar. 12, 2020.

(51) Int. Cl. B26B 9/02; B26B 3/00; B25G 1/10

(52) U.S. Cl. CPC B26B 9/02; B25G 1/102; B26B 3/00

(57) ABSTRACT

A knife with three active edges. The edges are banked and/or chamfered.

### CROSS REFERENCE TO RELATED APPLICATIONS

This application claims priority under 35 U.S.C. § 119 to U.S. provisional patent application Ser. No. 62/988,873 filed Mar. 12, 2020, and under 35 U.S.C. § 120 to U.S. design patent application Ser. No. 29/727,730 filed Mar. 12, 2020. The contents of the aforementioned applications are hereby incorporated herein by reference.

### FIELD OF THE INVENTION

The present invention relates generally to knives.

### SUMMARY

The present invention relates to a knife with three active edges, as compared to most knives which have only one or two active edges.

### DRAWINGS

FIG. 1 is a perspective view of a knife in accordance with an embodiment of the present invention.

FIG. 2 is a perspective view of the blade of the knife of FIG. 1.

FIG. 3 is a left side plan view of the knife of FIG. 1.

FIG. 4 is a left side plan view of the blade of the knife of FIG. 1.

FIG. 5 is a right side plan view of the knife of FIG. 1.

FIG. 6 is a right side plan view of the blade of the knife of FIG. 1.

### DETAILED DESCRIPTION

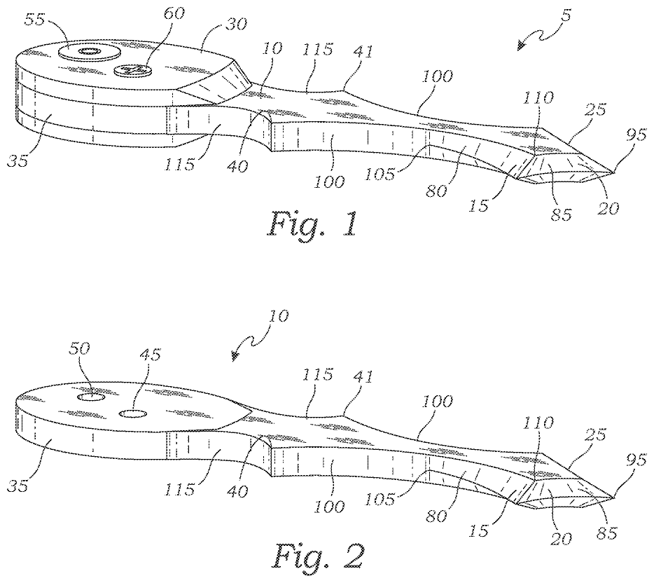

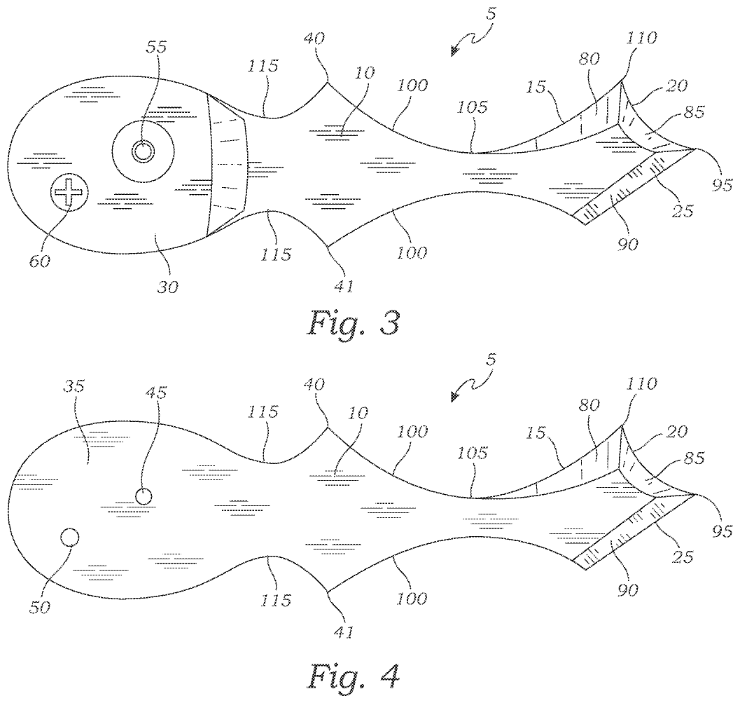

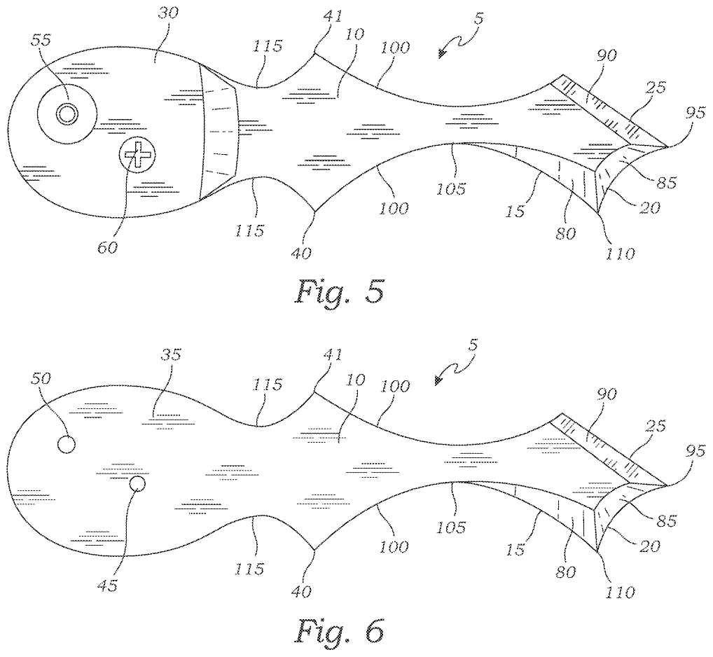

The present invention relates to a three-edged knife. FIG. 1 shows a knife 5 in accordance with an embodiment of the present invention. The knife 5 has a blade 10 and a handle 30. For reference purposes, the handle 30 is at the proximal end of the knife, and the tip 95 of the blade 10 is at the distal end of the knife.

FIG. 2 shows the blade 10 of the knife 5 without the handle 30. The blade 10 has three active edges, namely a first edge 15, a second edge 20, and a third edge 25. Each of the edges 15, 20, 25 can be used for cutting. The first edge 15 is curved along the longitudinal axis and is banked 80 similar to a car race track curve, and begins at 105 slightly distal of the longitudinal midpoint of the blade 10. The second edge 20 is also curved and banked 85, and extends from the distal most point 110 of the first edge 15 to the tip 95 of the blade 10. The third edge 25 is straight and chamfered 90 and extends from the tip 95 of the blade 10 back towards the tang 35.

The blade 10 also has upper and lower finger stops 40 and 41 respectively preventing the thumb and forefinger from sliding onto the edges 15, 20, and 25. The finger stops 40, 41 may be pointed or curved, smooth or rough, and may have ridges or other friction elements to help maintain grip. Likewise, they may be coated or covered with rubber, nylon, plastic, sandpaper, leather, rope, or other material. The blade 10 may have thumb/finger rests 115 proximal the finger stops 40, 41, i.e., from the tang 35 to the finger stops 40, 41, to help maintain positive grip. The thumb/finger rests 115 may be straight or curved, and may have ridges or other friction elements and/or be coated or covered as described above. The blade 10 may also have non-cutting edges 100 distal the finger stops 40, 41 but proximal the cutting edges 15, 20, 25. The non-cutting edges 100 are typically blunt, and act as a secondary safety buffer between the finger/thumb and the cutting edges 15, 20, 25. The non-cutting edges 100 may be straight or curved, and may have ridges or other friction elements and/or be coated or covered as described above.

The handle 30 may be any shape and size, and may cover all or part of the tang 35, which likewise may be any shape and size. Typically the shape and size of the handle 30 corresponds to the shape and size of the tang 35. The handle 30 may be attached by any conventional means. For example, the handle 30 may be one piece or two or more separate pieces, mounted using mounting hardware 55 and 60. Screws, threaded posts, rivets, pins or any suitable hardware will suffice. Glue may also be used in place of or in addition to the mounting hardware 55, 60. The hardware 55, 60 may be mated through mounting holes 45 and 50 in tang 35. The handle 30 may also be integrated with the blade 10; for example the handle 30 and blade 10 may be milled out of a single block of material (metal, plastic, composite, etc.).

Although particular embodiments and aspects of the present invention have been shown and described, it is not intended to limit the present invention to the preferred embodiments, and those skilled in the art will understand that various changes and modifications may be made without departing from the spirit and scope of the present invention. Thus, the present invention is intended to cover alternatives, modifications, and equivalents, which may be included within the spirit and scope of the present invention as defined by the claims.

What is claimed is:

1. A knife comprising:
a) a handle; and
b) a blade having a first active edge, a second active edge, and a third active edge.

2. The knife of claim 1, wherein the first active edge is banked.

3. The knife of claim 2, wherein the second active edge is banked.

4. The knife of claim 3, wherein the third active edge is chamfered.

5. The knife of claim 4, further comprising an upper finger stop distal relative to the handle, and proximal relative to the first, second, and third edges.

6. The knife of claim 5, further comprising a lower finger stop distal relative to the handle and proximal relative to the first, second, and third edges, the lower finger stop being on an opposite side of the knife from the upper finger stop.

7. The knife of claim 6, wherein the blade has a tang and a tip, and wherein the length of the blade from the most proximal part of the tang to the tip is greater than the widest width of the blade.

8. The knife of claim 7, further comprising a thumb rest proximal to the upper finger stop.

9. The knife of claim 1, further comprising an upper finger stop distal relative to the handle and proximal relative to the first, second, and third edges, and a lower finger stop distal relative to the handle and proximal relative to the first, second, and third edges, the lower finger stop being on an opposite side of the knife from the upper finger stop.

10. The knife of claim 1, wherein the blade has a tang and a tip, and wherein the length of the blade from the most proximal part of the tang to the tip is greater than the widest width of the blade.

11. The knife of claim 10, wherein the length of the blade from the most proximal part of the tang to the tip is at least twice the widest width of the blade.

12. A blade having a tang, a first active edge, a second active edge, and a third active edge.

13. The blade of claim 12, wherein the first active edge is banked.

14. The blade of claim 13, wherein the second active edge is banked.

15. Then blade of claim 14, wherein the third active edge is chamfered.

16. The blade of claim 15, further comprising an upper finger stop distal relative to the tang, and proximal relative to the first, second, and third edges.

17. The blade of claim 16, further comprising a lower finger stop distal relative to the tang, and proximal relative to the first, second, and third edges, the lower finger stop being on an opposite side of the blade from the upper finger stop.

18. The blade of claim 12, further comprising an upper finger stop distal relative to the tang, and proximal relative to the first, second, and third edges, and a lower finger stop distal relative to the tang, and proximal relative to the first, second, and third edges, the lower finger stop being on an opposite side of the blade from the upper finger stop.

19. The blade of claim 18, further comprising a thumb rest proximal to the upper finger stop.

20. The blade of claim 12, wherein the blade has a tip, and wherein the length of the blade from the most proximal part of the tang to the tip is greater than the widest width of the blade.
